(19) United States
(12) Patent Application Publication
(10) Pub. No.: US 2024/0421351 A1
(43) Pub. Date: Dec. 19, 2024

(54) ELECTRODE FOR SOLID-STATE BATTERY AND METHOD OF MANUFACTURING THE SAME, SOLID-STATE BATTERY AND METHOD OF MANUFACTURING THE SAME, AND BATTERY PACKAGE

(71) Applicant: MURATA MANUFACTURING CO., LTD., Kyoto (JP)

(72) Inventor: Daisuke ITO, Kyoto (JP)

(21) Appl. No.: 18/819,745

(22) Filed: Aug. 29, 2024

Related U.S. Application Data
(63) Continuation of application No. PCT/JP2023/009126, filed on Mar. 9, 2023.

(30) Foreign Application Priority Data
Mar. 28, 2022 (JP) 2022-051588

(51) Int. Cl. H01M 10/0562; H01M 4/02; H01M 4/04; H01M 4/131; H01M 4/133; H01M 4/1391; H01M 4/1393; H01M 4/62; H01M 10/0585

(52) U.S. Cl. CPC H01M 10/0562; H01M 4/0404; H01M 4/0416; H01M 4/131; H01M 4/133; H01M 4/1391; H01M 4/1393; H01M 4/622; H01M 10/0585; H01M 2004/027; H01M 2004/028; H01M 2300/0071; H01M 2300/008; H01M 2300/0091

(57) ABSTRACT

An electrode for a solid-state battery is provided and includes active material particles, a resin, and an inorganic solid-state electrolyte. The resin includes at least one selected from the group consisting of polyimide, polyamide, and polyamideimide and includes a carbide in part. The inorganic solid-state electrolyte includes a lithium salt that includes at least one element selected from the group consisting of boron (B), carbon (C), sulfur (S), and chlorine (Cl).

### CROSS REFERENCE TO RELATED APPLICATIONS

The present application is a continuation of PCT patent application no. PCT/JP2023/009126, filed on Mar. 9, 2023, which claims priority to Japanese patent application no. 2022-051588, filed on Mar. 28, 2022, the entire contents of which are herein incorporated by reference.

### BACKGROUND

The present technology relates to an electrode, for a solid-state battery, including a solid-state electrolyte and a method of manufacturing the same; a solid-state battery and a method of manufacturing the same; and a battery package.

Various kinds of electronic equipment, including mobile phones, have been widely used. Such widespread use has promoted development of a secondary battery as a power source that is smaller in size and lighter in weight and allows for a higher energy density.

The secondary battery includes a positive electrode, a negative electrode, and an electrolyte that are contained inside an outer package member.

Recently, a solid-state battery has been developed that is a secondary battery including a solid-state electrolyte instead of a liquid or gel electrolyte that includes a material such as an organic solvent.

### SUMMARY

Consideration has been given in various ways to improve performance of a solid-state battery, as described in the literatures in the above citation list. There is, however, room for improvement in terms of the performance of the solid-state battery.

It is therefore desirable to provide an electrode, for a solid-state battery, that is to be used to provide a solid-state battery having superior performance.

An electrode for a solid-state battery of an embodiment of the present disclosure includes active material particles, a resin, and an inorganic solid-state electrolyte. The resin includes at least one selected from the group consisting of polyimide, polyamide, and polyamideimide and includes a carbide in part. The inorganic solid-state electrolyte includes a lithium salt that includes at least one element selected from the group consisting of boron (B), carbon (C), sulfur (S), and chlorine (Cl).

According to the electrode for a solid-state battery of an embodiment of the present disclosure, the active material particles are strongly coupled to each other with the resin having a high bonding property, such as polyimide. In addition, the resin includes the carbide in part. The resin therefore forms a favorable electrically conductive network while having an elasticity (a softness). Accordingly, when the electrode for a solid-state battery of an embodiment of the present disclosure is applied to a solid-state battery, it is possible to achieve superior performance such as a high capacity and high output.

Note that effects of the present disclosure are not necessarily limited to those described herein and may include any of a series of effects in relation to the present disclosure.

### BRIEF DESCRIPTION OF THE FIGURES

FIG. 1 is a schematic sectional diagram illustrating an example of a configuration of an electrode for a solid-state battery as an embodiment of the present disclosure.

FIG. 2 is a flowchart illustrating an example of a manufacturing process of the electrode for a solid-state battery illustrated in FIG. 1.

FIG. 3 is a schematic sectional diagram illustrating a configuration of a battery package as an embodiment of the present disclosure.

FIG. 4 is a sectional diagram illustrating a configuration of a solid-state battery illustrated in FIG. 3.

FIG. 5 is a schematic sectional diagram illustrating an example of a configuration of a solid-state electrolyte layer illustrated in FIG. 4.

### DETAILED DESCRIPTION

The present disclosure is described below in further detail including with reference to the drawings according to an embodiment. Note that a “solid-state battery” of the present disclosure refers to a battery including a component that is in a solid state. For example, the “solid-state battery” of the present disclosure is a stacked-type solid-state battery in which layers are stacked on each other. The layers each include, for example, a sintered body. The “solid-state battery” of the present disclosure encompasses not only a secondary battery that is repeatedly chargeable and dischargeable but also a primary battery that is simply dischargeable. The “electrode for a solid-state battery” of the present disclosure is also applicable to wound batteries (of a coin type, a cylindrical type, and a pouch type, for example).

First, an outline of the present disclosure is described according to an embodiment. Consideration has been given in various ways in relation to improvement in performance of a solid-state battery. For example, a solid-state battery is disclosed that stably operates by including, for example, a solid-state electrolyte layer including a material having a grass transition point of 500° C. or lower at a predetermined volume ratio. A technique of forming a positive electrode is disclosed having a favorable interface between an active material and a solid-state electrolyte by: applying a mixture slurry in which Li₃BO₃ to be melted at 700° C. is added onto a solid-state electrolyte and a positive electrode active material; and heating the mixture slurry at 700° C. to melt the mixture slurry and to impregnate the solid-state electrolyte and the positive electrode active material with the mixture slurry. Further, a technique of forming a positive electrode is disclosed including a solid-state electrolyte with a high density by pressing a composite glass body of Li₃BO₃ and Li₂SO₄ (a solid-state electrolyte) under an ultra-high pressure of 720 MPa at room temperature. The composite glass body has a hardness lower than that of Li₃BO₃.

However, it is considered that an electrically conductive property is not high; therefore, such techniques are not suitable for increasing a thickness of the positive electrode (for example, increasing the thickness to 20 μm or larger). For example, surroundings of conductive additive particles are also impregnated with Li₃BO₃ that is an insulator. It is therefore expected that increasing the thickness of the positive electrode leads to insufficiency of the electrically conductive property of the positive electrode. The composite glass body impairs formation of a contact with a conductive additive. It is therefore expected that increasing the thickness of the positive electrode leads to insufficiency of the electrically conductive property of the positive electrode. Note that a possible way to improve the electrically conductive property is to add the conductive additive. However, increasing an amount of the added conductive additive results in embrittlement of an electrode. This leads to a concern about an issue such as occurrence of an electrode crack in a battery formation process.

Further, a technique is disclosed of forming a positive electrode and a negative electrode each including a solid-state electrolyte by mixing the solid-state electrolyte and an active material into an electrospun nonwoven fabric. However, in a method, for example, processes including formation of the electrospun nonwoven fabric and mixing an electrode material slurry into the nonwoven fabric are complicated. Further, it is difficult in manufacturing to uniformly mix an electrode material into the nonwoven fabric with an accuracy of 1 mg/cm² or lower. Therefore, such method is not suitable for mass production. In addition, mixing the solid-state electrolyte in powder form makes it difficult to form a favorable interface between the active material and the solid-state electrolyte.

In view of the above-described circumstances, the present application relates, in an embodiment, relates to providing an electrode, for a solid-state battery, having a higher electrically conductive property, and a solid-state battery including the same.

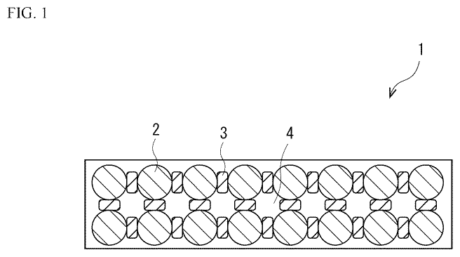

Referring to FIG. 1, a description is given of an electrode 1 for a solid-state battery as a first embodiment of the present disclosure. FIG. 1 is a schematic sectional diagram schematically illustrating an example of a configuration of the electrode 1 for a solid-state battery. The electrode 1 for a solid-state battery includes active material particles 2, a resin 3, and a solid-state electrolyte 4.

The active material particles 2 each include, without particular limitation, a positive electrode material or a negative electrode material which an electrode reactant such as a lithium ion is insertable into and extractable from.

The resin 3 is so provided as to couple the active material particles 2 to each other. The resin 3 includes a polymer compound carbonized in part. The polymer compound includes at least one selected from the group consisting of polyimide, polyamide, and polyamideimide. That is, the resin 3 includes a carbide of an imide in part. The polymer compound being carbonized in part allows for formation of an electrically conductive path that couples the active material particles 2 to each other. As used herein, the wording “the polymer compound being carbonized in part” refers to a state where not the entire polymer compound included in the resin 3 is carbonized to form a C—C bond and an imide bond remains in the resin 3. In addition, the resin preferably has a void inside. It is preferable that the void inside the resin 3 be distributed, for example, over the entire electrode 1 for a solid-state battery, and filled with the solid-state electrolyte 4. Note that filling the void inside the resin 3 with the solid-state electrolyte 4 is a concept encompassing not only completely filling the void inside the resin 3 with the solid-state electrolyte 4, but also allowing the void inside the resin 3 to be occupied in part by the solid-state electrolyte 4. Carbonization of the resin 3 in part is detectable by, for example, Raman spectroscopy. When the resin 3 includes a carbide in which an imide is carbonized, a peak near 1350 cm⁻¹ (a carbon D-band) and a peak near 1600 cm⁻¹ (a carbon G-band) appear in a Raman spectrum. The imide bond included in the resin 3 is detectable by, for example, a fluorescence method using a fluorometer or infrared spectroscopy (FT-IR). In the fluorescence method, when the imide bond remains, fluorescence (light emission) is detected in a visible light region. In infrared spectroscopy, a peak derived from an imide group is detectable near 1520 cm⁻¹ or near 1775 cm⁻¹. As described above, in the electrode 1 for a solid-state battery, the imide bond remains in the resin 3. Accordingly, the electrode 1 for a solid-state battery exhibits a higher softness, as compared with when the entire polymer compound included in the resin 3 is carbonized to form a C—C bond. The softness may be evaluated, for example, by a bending test.

The solid-state electrolyte 4 includes a lithium salt that includes at least one element selected from the group consisting of boron (B), carbon (C), sulfur (S), and chlorine (Cl). Specifically, the solid-state electrolyte 4 preferably includes at least one of Li₂CO₃, Li₂SO₄, Li₃BO₃, Li₃OCl, or Li₂OHCl as a major component material. The solid-state electrolyte 4 is so provided in a gap between the active material particles 2 as to fill the gap between the active material particles 2. The solid-state electrolyte 4 is preferably provided also in the void in the resin 3 carbonized in part and gaps between the resin 3 and the active material particles 2. Note that, the solid-state electrolyte 4 may have a pore inside. In addition, the solid-state electrolyte 4 and a part of the active material particles 2 may have a gap therebetween. In addition, the solid-state electrolyte 4 desirably has no particle interface therein. This is to achieve a superior electrically conductive property of the electrode 1 for a solid-state battery. The solid-state electrolyte 4 is, for example, an electrolyte resulting from causing a molten lithium salt to permeate the gap between the active material particles 2 and thereafter crystallizing the molten lithium salt. The molten lithium salt is a salt resulting from melting the above-described lithium salt.

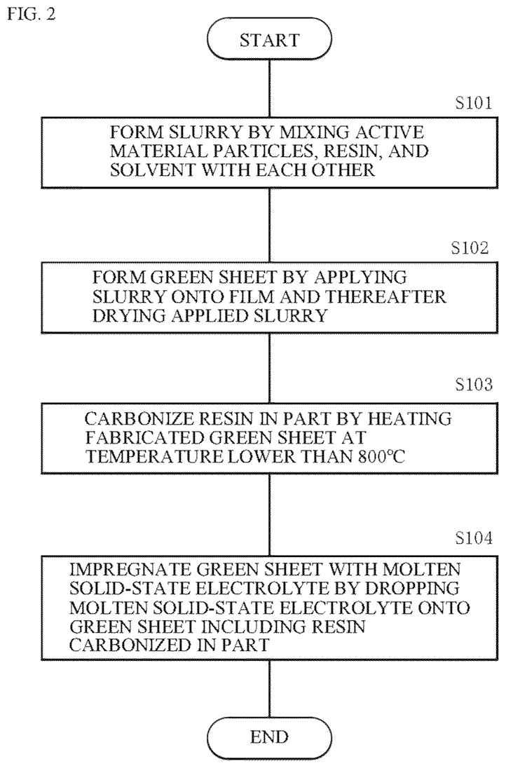

Referring to FIG. 2, a description is given next of an example of a method of manufacturing the electrode 1 for a solid-state battery. FIG. 2 is a flowchart illustrating an example of a manufacturing process of the electrode 1 for a solid-state battery. The electrode 1 for a solid-state battery may be formed by, for example, a green sheet method in which a green sheet is used. One manufacturing method is described below as an example; however, the present technology is not limited to the following manufacturing method. Temporal matters such as the order of descriptions below are merely for description convenience, and the present technology is not limited thereto.

First, a slurry is formed by mixing active material particles, a resin, and a solvent with each other (step S101). Upon forming the slurry, any additive such as a conductive additive may be added. Used as the resin is a polymer compound including at least one selected from the group consisting of polyimide, polyamide, and polyamideimide. In an example, when polyimide is used as the resin, a polyimide solution is prepared by dissolving polyimide in NMP (N-methyl-2-pyrrolidone) as a solvent at a solid content concentration of 18.6%. Thereafter, the polyimide solution is mixed into the active material particles with a mixture ratio within a range from about 10 wt % to about 30 wt % with respect to the active material particles to prepare a mixture liquid. Thereafter, the mixture liquid is stirred by means of, for example, a hybrid mixer for a predetermined period of time to form a slurry. Alternatively, a mixture of the active material particles and solid-state electrolyte powder may be put into the polyimide solution to prepare a mixture liquid.

Thereafter, a green sheet is formed by applying the slurry onto a film and thereafter drying the applied slurry by means of, for example, an oven (step S102). Used as the film onto which the slurry is to be applied may be, for example, a release film including polyethylene terephthalate (PET) or a metal foil.

Thereafter, the formed green sheet is heated at a temperature of 800° C. or lower to thereby carbonize the resin in part (step S103). In this heating process, the green sheet may be placed in a vacuum furnace and heated under a pressure of 10⁻² Pa or lower at a temperature of 700° C. for 1 hour. Such a heating process allows for formation of an electrically conductive network in which the active material particles 2 are bound to each other by the resin 3, such as polyimide, that is carbonized in part. Carbonizing the resin in part by the heating process results in a decrease in volume of the resin, which causes the resin 3 to have a void inside. The void formed inside the resin 3 at this time is desirably a communication hole that has a curved-path shape and is provided through the entire green sheet. A reason for this is that the green sheet is more easily impregnated with a molten solid-state electrolyte in step S104 to be described below. In addition, in step S103, the green sheet is preferably heated at a temperature of higher than or equal to 550° C. and lower than or equal to 700° C. A reason for this is that the heated green sheet further improves in a softness and an electrically conductive property. Note that in a case where the slurry is applied onto the release film in step S102, the release film is removed from the green sheet before performing the heating process.

Thereafter, the green sheet having been subjected to the heating process is impregnated with the molten solid-state electrolyte by, for example, dropping the molten solid-state electrolyte onto the green sheet (step S104). This allows the molten solid-state electrolyte to permeate, for example, the gap between the active material particles 2 and the gaps between the active material particles 2 and the resin 3 carbonized in part. As the molten solid-state electrolyte, it is preferable to use a molten lithium salt including at least one of Li₂CO₃, Li₂SO₄, Li₃BO₃, Li₃OCl, or Li₂OHCl. Lastly, the molten solid-state electrolyte is crystallized by performing a drying process.

The manufacturing of the electrode 1 for a solid-state battery is thus completed. Note that the electrode 1 for a solid-state battery may have a stacked structure in which an active material layer including an active material is provided on a current collector such as a metal foil. When the electrode 1 for a solid-state battery has such a stacked structure, for example, in step S102, the slurry is applied onto the metal foil as the current collector, and the applied slurry is dried, following which a stacked body of the metal foil and the dried slurry is subjected to the heating process in step S103. A heating temperature in the heating process is preferably adjusted in accordance with a kind (a melting point) of the metal foil. For example, when the metal foil is an aluminum foil, the heating temperature, is preferably higher than or equal to 550° C. and lower than or equal to 600° C. When the metal foil is a stainless steel foil or a copper foil, the heating temperature is preferably higher than or equal to 550° C. and lower than or equal to 700° C. When the green sheet is fabricated in a film shape instead of applying the slurry onto the metal foil, the stacked structure may be fabricated by stacking, on the metal foil as the current collector, the green sheet that has been fabricated through steps S101 to S104, and thereafter compression-bonding the green sheet and the metal foil to each other by pressing to integrate the green sheet the metal foil with each other.

The electrode 1 for a solid-state battery of an embodiment includes the active material particles 2, the resin 3, and the solid-state electrolyte 4. The resin 3 includes at least one selected from the group consisting of polyimide, polyamide, and polyamideimide, and is carbonized in part. The solid-state electrolyte 4 includes the lithium salt that includes at least one element selected from the group consisting of B, C, S, and Cl. Therefore, according to the electrode 1 for a solid-state battery, the active material particles 2 are strongly coupled to each other with the resin 3 having a high binding property, such as polyimide. In addition, the resin 3 is carbonized in part. Accordingly, the resin 3 has elasticity and has a favorable electrically conductive property. This allows the electrode 1 for a solid-state battery to form a favorable electrically conductive network while having elasticity. It is therefore possible for an electrode to have a larger thickness when the electrode 1 for a solid-state battery is applied to a solid-state battery. This makes it possible to achieve superior performance such as a high capacity and high output.

For example, when polyimide is fired at a temperature exceeding 800° C., more imides are decomposed to increase a proportion of the C—C bond, resulting in a high possibility of decreasing the elasticity of the electrode 1 for a solid-state battery and embrittling the electrode 1 for a solid-state battery. In the method of manufacturing the electrode 1 for a solid-state battery of an embodiment, the resin 3 is carbonized merely in part at a process temperature of 800° C. or lower. This makes it possible to allow the electrode 1 for a solid-state battery to have softness.

In the electrode 1 for a solid-state battery of an embodiment, the void inside the resin 3 is filled with the solid-state electrolyte 4. This makes it possible to achieve a superior electrically conductive property.

Further, the electrode 1 for a solid-state battery of an embodiment allows the lithium salt included in the solid-state electrolyte 4 to be melted, allows the active material particles 2 to be impregnated with the molten lithium salt, and allows the molten lithium salt to be thereafter crystallized. This helps to prevent easy generation of an interface between particles of the solid-state electrolyte 4. Because the interface between the particles of the solid-state electrolyte 4 decreases an ion conductivity, reducing such an interface between the particles of the solid-state electrolyte 4 makes it possible to achieve a favorable electrically conductive property.

In the method of manufacturing the electrode 1 for a solid-state battery of an embodiment, before impregnating the green sheet with the molten solid-state electrolyte, a strong electrically conductive network in which the resin 3 carbonized in part and the active material particles 2 are bound to each other is formed by the heating process in advance. Accordingly, even if the green sheet is impregnated with the solid-state electrolyte, the electrically conductive network is maintained. Because the resin 3 carbonized in part has elasticity, the green sheet that has been heated in the manufacturing process does not crack easily, which allows the green sheet to be easily handled.

The polymer compound including at least one selected from the group consisting of polyimide, polyamide, and polyamideimide each of which has been carbonized in part is chemically stable in an inert atmosphere at a temperature of 800° C. or lower. Accordingly, when a temperature of the molten solid-state electrolyte is lower than 800° C. in a vacuum atmosphere or an inert atmosphere, it is possible to avoid disconnection of the electrically conductive network caused by an impregnation process. Note that the solid-state electrolyte 4 including at least one of Li₂CO₃, Li₂SO₄, Li₃BO₃, Li₃OCl, or Li₂OHCl is melted at a temperature lower than 800° C. Accordingly, when the one or more lithium salts are melted and the green sheet is impregnated with the one or more molten lithium salts, it is possible to stably maintain a strong electrically conductive network in which the resin 3 carbonized in part and the active material particles 2 are bound to each other.

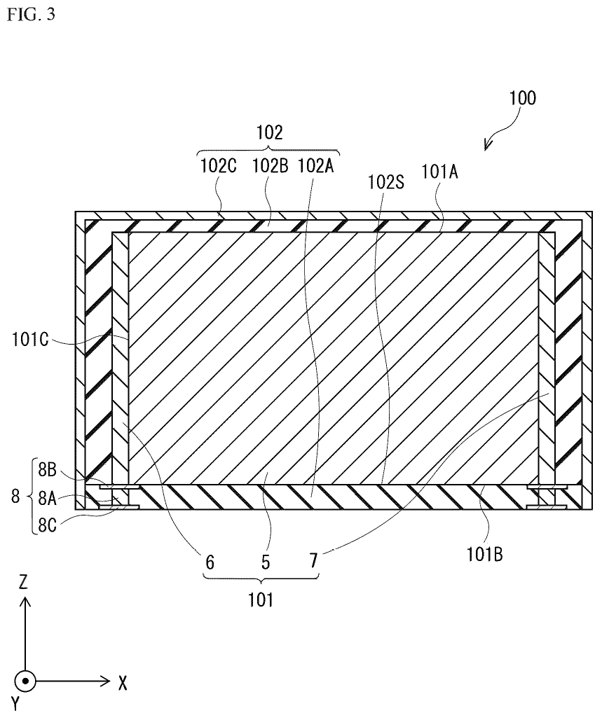

A description is given next of a battery package 100 of a second embodiment of the present disclosure. FIG. 3 is a schematic sectional diagram schematically illustrating an overall configuration of the battery package 100. The battery package 100 includes a solid-state battery 101 and a covering part 102 that covers the solid-state battery 101. The solid-state battery 101 is protected from an external environment by the covering part 102. The covering part 102 helps to prevent entry of, for example, water vapor into the solid-state battery 101. In the following, a description is given of the solid-state battery 101, and thereafter of the covering part 102. As used herein, the term “water vapor” refers to moisture typified by water vapor in the atmosphere, and refers to moisture encompassing not only water vapor in a gas state but also water in a liquid state in some preferred embodiments. The solid-state battery 101 protected against permeation of such moisture is preferably packaged to be suitable for mounting on a substrate, in particular, for mounting on a surface.

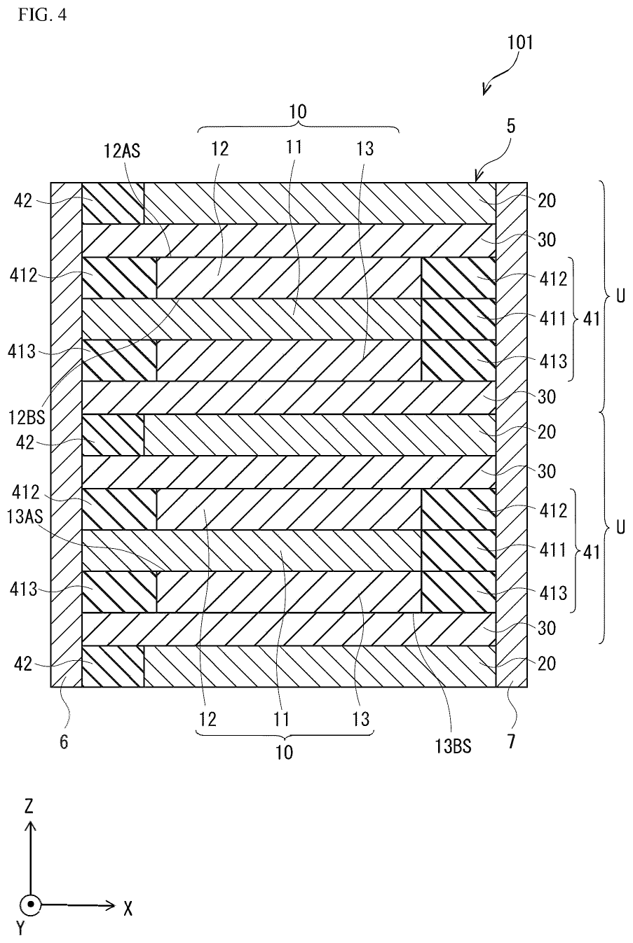

FIG. 4 is a schematic sectional diagram schematically illustrating a configuration of the solid-state battery 101. As illustrated in FIGS. 3 and 4, the solid-state battery 101 includes a stacked body 5, a positive electrode terminal 6, and a negative electrode terminal 7. The positive electrode terminal 6 and the negative electrode terminal 7 are opposed to each other with the stacked body 5 interposed therebetween. As illustrated in FIG. 4, the stacked body 5 includes a positive electrode layer 10, a negative electrode layer 20, and a solid-state electrolyte layer 30 that are stacked on each other in a Z-axis direction. The solid-state electrolyte layer 30 is interposed between the positive electrode layer 10 and the negative electrode layer 20 in the Z-axis direction that is a stacking direction. The solid-state battery 101 specifically has a structure in which multiple units U are stacked on each other in the Z-axis direction. The units U each serve as a single unit and each include the negative electrode layer 20, the solid-state electrolyte layer 30, the positive electrode layer 10, and the solid-state electrolyte layer 30 that are stacked on each other in order. Note that FIG. 4 illustrates the solid-state battery 101 including two units U; however, the solid-state battery 101 is not limited to this example, and may include three or more units U. The solid-state battery 101 may further include margin layers 41 and 42 that are each an electron insulating layer. The margin layer 41 is provided at the same layer level as a portion of the positive electrode layer 10. The margin layer 42 is provided at the same layer level as a portion of the negative electrode layer 20.

The positive electrode layer 10 and the negative electrode layer 20 may each include a conductive additive. The conductive additive that may be included in each of the positive electrode layer 10 and the negative electrode layer 20 may include, for example, at least one selected from the group consisting of, for example: a metal material such as silver, palladium, gold, platinum, copper, or nickel; and carbon. The conductive additive included in the positive electrode layer 10 and the conductive additive included in the negative electrode layer 20 may be of the same kind, or may be of respective kinds different from each other.

In addition, the positive electrode layer 10 and the negative electrode layer 20 may each include a sintering aid. The sintering aid may include, for example, at least one selected from the group consisting of lithium oxide, sodium oxide, potassium oxide, boron oxide, silicon oxide, bismuth oxide, and phosphorous oxide. The sintering aid included in the positive electrode layer 10 and the sintering aid included in the negative electrode layer 20 may be of the same kind, or may be of respective kinds different from each other.

The positive electrode layer 10 is an electrode layer including at least a positive electrode active material. In the solid-state battery 101 illustrated in FIG. 4, the positive electrode layer 10 includes a stacked structure including a positive electrode current collector 11 and a pair of positive electrode active material layers 12 and 13.

The positive electrode current collector 11 is, for example, a metal foil such as an aluminum foil. Alternatively, the positive electrode current collector 11 may be a sintered body. This is to reduce an internal resistance of the positive electrode current collector 11. When the positive electrode current collector 11 is the sintered body, the positive electrode current collector 11 may include a conductive additive and a sintering aid. The conductive additive included in the positive electrode current collector 11 may be of the same kind as the conductive additive included in, for example, the positive electrode active material layers 12 and 13. The sintering aid included in the positive electrode current collector 11 may be of the same kind as the sintering aid included in, for example, the positive electrode active material layers 12 and 13. Note that FIG. 4 illustrates, as an example, an embodiment where the positive electrode layer 10 includes the positive electrode current collector 11; however, the positive electrode current collector 11 is not an essential component. In some embodiments, the positive electrode layer 10 may include no positive electrode current collector 11 and may include either the positive electrode active material layer 12 or the positive electrode active material layer 13.

The positive electrode active material layers 12 and 13 each include the positive electrode active material as a major component. The positive electrode active material layer 12 is provided on an upper surface of the positive electrode current collector 11, and the positive electrode active material layer 13 is provided on a lower surface of the positive electrode current collector 11. The example of the configuration, with no metal foil, of the electrode 1 for a solid-state battery described in the first embodiment above is adoptable for each of the positive electrode active material layers 12 and 13.

The positive electrode active material included in each of the positive electrode active material layers 12 and 13 contributes to insertion and extraction of an ion in the solid-state battery 101 and also contributes to supplying and receiving of an electron to and from an external circuit. The ion moves between the positive electrode layer 10 and the negative electrode layer 20 via the solid-state electrolyte. In other words, ion conduction occurs between the positive electrode layer 10 and the negative electrode layer 20 via the solid-state electrolyte. The insertion and extraction of the ion into and from the positive electrode active material involve reduction and oxidation of the positive electrode active material. An electron and a hole for such reduction and oxidation reactions are respectively supplied from the external circuit to the positive electrode terminal 6 and the negative electrode terminal 7, and further respectively supplied to the positive electrode layer 10 and the negative electrode layer 20. This allows charging and discharging to proceed. The positive electrode active material layers 12 and 13 are each, for example, a layer which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. That is, the solid-state battery 101 is preferably an all-solid-state secondary battery that is to be charged and discharged by the above-described ion moving between the positive electrode layer 10 and the negative electrode layer 20 via the solid-state electrolyte.

The positive electrode active material included in the positive electrode layer 10 includes, for example, at least one selected from the group consisting of, for example, a lithium-containing phosphoric acid compound having a NASICON structure, a lithium-containing phosphoric acid compound having an olivine structure, a lithium-containing layered oxide, and a lithium-containing oxide having a spinel structure. Examples of the lithium-containing phosphoric acid compound having the NASICON structure include Li₃V₂(PO₄)₃. Examples of the lithium-containing phosphoric acid compound having the olivine structure include Li₃Fe₂(PO₄)₃, LiFePO₄, LiMnPO₄, and LiFe_{0.6}Mn_{0.4}PO₄. Examples of the lithium-containing layered oxide include LiCoO₂, LiCo_{1/3}Ni_{1/3}Mn_{1/3}O₂, and LiCo_{0.8}Ni_{0.15}Al_{0.05}O₂. Examples of the lithium-containing oxide having the spinel structure include LiMn₂O₄ and LiNi_{0.5}Mn_{1.5}O₄.

The positive electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, a sodium-containing layered oxide, and a sodium-containing oxide having a spinel structure.

The negative electrode layer 20 is an electrode layer including at least a negative electrode active material. The example of the configuration, with no metal foil, of the electrode 1 for a solid-state battery described in the first embodiment above is adoptable for the negative electrode layer 20. The negative electrode layer 20 may include a negative electrode current collector. The negative electrode current collector is, for example, a metal foil such as a copper foil. Alternatively, the negative electrode current collector may be a sintered body. This is to reduce an internal resistance of the negative electrode current collector. When the negative electrode current collector is the sintered body, the negative electrode current collector may include a conductive additive and a sintering aid.

As with the positive electrode active material included in the positive electrode layer 10, the negative electrode active material included in the negative electrode layer 20 contributes to insertion and extraction of an ion in the solid-state battery 101 and also contributes to supplying and receiving of an electron to and from an external circuit. The ion moves between the positive electrode layer 10 and the negative electrode layer 20 via the solid-state electrolyte layer 30. In other words, ion conduction occurs between the positive electrode layer 10 and the negative electrode layer 20 via the solid-state electrolyte layer 30. The insertion and extraction of the ion into and from the negative electrode active material involve oxidation and reduction of the negative electrode active material. An electron and a hole for such oxidation and reduction reactions are respectively supplied from the external circuit to the positive electrode terminal 6 and the negative electrode terminal 7, and further respectively supplied to the positive electrode layer 10 and the negative electrode layer 20, which allows charging and discharging to proceed. The negative electrode active material is, for example, a material which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. The negative electrode active material included in the negative electrode layer 20 includes, for example, at least one selected from the group consisting of, for example: an oxide including at least one element selected from the group consisting of Ti, Si, Sn, Cr, Fe, Nb, and Mo; a graphite-lithium compound; a lithium alloy; a lithium-containing phosphoric acid compound having a NASICON structure; a lithium-containing phosphoric acid compound having an olivine structure; and a lithium-containing oxide having a spinel structure. Examples of the lithium alloy include Li—Al. Examples of the lithium-containing phosphoric acid compound having the NASICON structure include Li₃V₂(PO₄)₃ and LiTi₂(PO₄)₃. Examples of the lithium-containing phosphoric acid compound having the olivine structure include Li₃Fe₂(PO₄)₃ and LiCuPO₄. Examples of the lithium-containing oxide having the spinel structure include Li₄Ti₅O₁₂.

The negative electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, and a sodium-containing oxide having a spinel structure.

The solid-state electrolyte included in the solid-state electrolyte layer 30 is, for example, a material conductive of an ion such as a lithium ion or a sodium ion. In particular, the solid-state electrolyte forming a battery configuration unit in a solid-state battery forms a layer conductive of, for example, a lithium ion between the positive electrode layer 10 and the negative electrode layer 20. Specific examples of the solid-state electrolyte include a lithium-containing phosphoric acid compound having a NASICON structure, an oxide having a perovskite structure, and an oxide having a garnet structure or a garnet-like structure. The lithium-containing phosphoric acid compound having the NASICON structure is, for example, LiₓM_{y}(PO₄)₃(where 1≤x≤2, 1≤y≤2, and M includes at least one selected from the group consisting of Ti, Ge, Al, Ga, and Zr). Examples of the lithium-containing phosphoric acid compound having the NASICON structure include Li_{1.2}Al_{0.2}Ti_{1.8}(PO₄)₃. Examples of the oxide having the perovskite structure include La_{0.55}Li_{0.35}TiO₃. Examples of the oxide having the garnet structure or the garnet-like structure include Li₇La₃Zr₂O₁₂. Examples of the solid-state electrolyte conductive of a sodium ion include a sodium-containing phosphoric acid compound having a NASICON structure, an oxide having a perovskite structure, and an oxide having a garnet structure or a garnet-like structure. Examples of the sodium-containing phosphoric acid compound having the NASICON structure include NaₓM_{y}(PO₄)₃(where 1≤x≤2, 1≤y≤2, and M includes at least one selected from the group consisting of Ti, Ge, Al, Ga, and Zr). Further, a sulfide or a halide is also adoptable for the solid-state electrolyte included in the solid-state electrolyte layer 30. Examples of the sulfide include: Li₇PS₆ having an argyrodite structure; a material resulting from substituting a portion thereof, such as Li₆PS₅Cl or Li₆PS₅Br; Li₁₀GeP₂S₁₂ having a LISICON structure; and a material resulting from substituting a portion thereof, such as Li₁₀SiP₂S₁₂ or Li_{9.54}Si_{1.74}P_{1.44}S_{11.7}C_{10.3}. Examples of the halide include: Li₂MCl₄ having an inverse spinel structure where M includes at least one of Mg, Fe, Ni, Zn, Al, In, or Sc; and Li₃MCl₆ having a monoclinic structure where M includes at least one of Al, Ga, In, Sc, or Y.

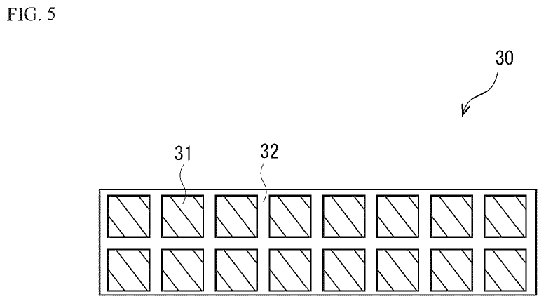

For example, as illustrated in FIG. 5, the solid-state electrolyte layer 30 may be a mixture that includes a first solid-state electrolyte 31 having a perovskite structure and a second solid-state electrolyte 32 having an antiperovskite structure. FIG. 5 is a schematic sectional diagram schematically illustrating an example of a configuration of the solid-state electrolyte layer 30. Combining the first solid-state electrolyte 31 having the perovskite structure and the second solid-state electrolyte 32 having the antiperovskite structure allows the solid-state electrolyte layer 30 to be in a favorable lattice-matched state. Specifically, the first solid-state electrolyte 31 includes electrolyte particles, and the second solid-state electrolyte 32 fills a gap between the pieces of the first solid-state electrolyte 31 in particle form. In the solid-state electrolyte layer 30, for example, the first solid-state electrolyte 31 is dispersed in and surrounded by the second solid-state electrolyte 32. Accordingly, the second solid-state electrolyte 32 includes few grain boundaries. Suppressing formation of the grain boundaries in the second solid-state electrolyte 32 allows the solid-state electrolyte layer 30 to have a high ion conductivity, making it possible for the solid-state battery 101 to allow for, for example, fast charging and high output.

It is desirable that the first solid-state electrolyte 31 having the perovskite structure and the second solid-state electrolyte 32 having the antiperovskite structure have respective lattice constants of crystals that are similar to each other. The perovskite structure and the antiperovskite structure are reversed structures in terms of arrangement of cations having positive charge and anions having negative charge. Therefore, if the lattice constant of the perovskite structure and the lattice constant of the antiperovskite structure are similar to each other, positive charge and negative charge are to be positioned adjacent to each other when the perovskite structure and the antiperovskite structure are brought into contact with each other. This allows for formation of an ionic bond in a lattice-matched state with less misalignment in ion configuration, providing a very clean interface between the first solid-state electrolyte 31 and the second solid-state electrolyte 32. As used herein, the term “clean interface” refers to an interface in an epitaxial state (a lattice-matched state) with a markedly small number of structural defects. Further, the term “lattice-matched state” refers to, for example, a state where a ratio of the lattice constant of the antiperovskite structure to the lattice constant of the perovskite structure is greater than or equal to 0.9 and less than or equal to 1.1. In particular, the ratio of the lattice constant of the antiperovskite structure to the lattice constant of the perovskite structure is desirably greater than or equal to 0.95 and less than or equal to 1.05.

Used as each of the first solid-state electrolyte 31 and the second solid-state electrolyte 32 may be a solid-state electrolyte having a lattice constant that is an integer multiple of a value of greater than or equal to 3.8 Å and less than or equal to 4.1 Å. Specifically, the first solid-state electrolyte 31 is preferably Li_{0.33}La_{0.56}TiO₃, and the second solid-state electrolyte 32 is preferably Li₃OCl or Li₂(OH)Cl. The lattice constant of Li_{0.33}La_{0.56}TiO₃ is 3.92 Å. The lattice constant of Li₃OCl and the lattice constant of Li₂(OH)Cl are each 3.91 Å.

The solid-state electrolyte layer 30 may include a sintering aid. The sintering aid that may be included in the solid-state electrolyte layer 30 may be selected from, for example, materials similar to the sintering aids that may be included in the positive electrode layer 10 and the negative electrode layer 20. When the solid-state electrolyte layer 30 is not to be sintered in course of forming the solid-state electrolyte layer 30, the solid-state electrolyte layer 30 may include a binder instead of the sintering aid.

The positive electrode terminal 6 and the negative electrode terminal 7 are each an external coupling terminal adapted to couple the stacked body 5 and an external device to each other. The positive electrode terminal 6 and the negative electrode terminal 7 are each preferably provided as an end face electrode on a side surface of the stacked body 5. That is, the positive electrode terminal 6 and the negative electrode terminal 7 each extend along the Z-axis direction that is the stacking direction of the stacked body 5. In FIG. 4, the positive electrode terminal 6 and the negative electrode terminal 7 are opposed to each other in an X-axis direction. The positive electrode terminal 6 is electrically coupled to an end face of the positive electrode current collector 11 of the positive electrode layer 10, as illustrated in FIG. 4. The negative electrode terminal 7 is electrically coupled to an end face of the negative electrode layer 20. The positive electrode terminal 6 and the negative electrode terminal 7 each preferably include a material having a high electrical conductivity. The positive electrode terminal 6 and the negative electrode terminal 7 may each include, for example, at least one material selected from the group consisting of gold, silver, platinum, aluminum, tin, nickel, copper, manganese, cobalt, iron, titanium, and chromium. However, the material included in each of the positive electrode terminal 6 and the negative electrode terminal 7 is not limited to the above-described materials.

The margin layer 41 includes margin parts 411 to 413. The margin part 411 is provided at the same layer level as the positive electrode current collector 11, between the positive electrode current collector 11 and the negative electrode terminal 7. The margin part 412 is provided at the same layer level as the positive electrode active material layer 12, between the positive electrode active material layer 12 and each of the positive electrode terminal 6 and the negative electrode terminal 7. The margin part 413 is provided at the same layer level as the positive electrode active material layer 13, between the positive electrode active material layer 13 and each of the positive electrode terminal 6 and the negative electrode terminal 7. The margin layer 42 is provided at the same layer level as the negative electrode layer 20, between the negative electrode layer 20 and the positive electrode terminal 6.

The margin parts 411 to 413 of the margin layer 41 and the margin layer 42 each include, for example, a material having an electron insulating property. The material having the electron insulating property is hereinafter simply referred to as an “insulating material”.

Examples of the insulating material include a glass material and a ceramic material. The glass material may include, without limitation, at least one selected from the group consisting of soda-lime glass, potash glass, boric-acid-salt-based glass, borosilicic-acid-salt-based glass, barium-borosilicate-based glass, zinc-borate-based glass, barium-borate-based glass, bismuth-borosilicate-salt-based glass, bismuth-zinc-borate-based glass, bismuth-silicate-based glass, phosphoric-acid-salt-based glass, aluminophosphate-based glass, and zinc-phosphate-based glass, for example. The ceramic material may include, without limitation, at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃), for example. The insulating material may be a mechanically superior organic substance. Examples of the mechanically superior organic substrate include polyimide, polyamide, polyamideimide, polyvinylidene difluoride (PVDF), polytetrafluoroethylene (PTFE), and a polyether ether ketone (PEEK) resin.

The insulating material included in each of the margin layers 41 and 42 may include a solid-state electrolyte. In such a case, the solid-state electrolyte included in the insulating material is preferably the same material as the solid-state electrolyte included in the solid-state electrolyte layer 30. A reason for this is that such a configuration makes it possible to further improve a binding property between each of the margin layers 41 and 42 and the solid-state electrolyte layer 30.

As illustrated in FIG. 3, the covering part 102 of the battery package 100 includes a support substrate 102A, an insulating covering film 102B, and an inorganic covering film 102C. In the battery package 100, the entire solid-state battery 101 is surrounded by the covering part 102. In other words, the covering part 102 is so provided as to prevent the solid-state battery 101 from being exposed to an outside.

The support substrate 102A is a plate-shaped member that supports the solid-state battery 101. The support substrate 102A includes a surface 102S opposed to a bottom surface 101B that is a major surface of the solid-state battery 101. The support substrate 102A may be a resin substrate, or may be a ceramic substrate. In some preferred embodiments, the support substrate 102A is the ceramic substrate. The support substrate 102A includes ceramics as a major component. The support substrate 102A that is the ceramic substrate is superior in preventing permeation of water vapor and in heat resistance, which is preferable. The ceramic substrate may be obtained by, for example, firing a green sheet stacked body. Specifically, the ceramic substrate may be a low-temperature co-fired ceramic (LTCC) substrate, or may be a high-temperature co-fired ceramic (HTCC) substrate. Although the following ranges are mere examples, the support substrate 102A has a thickness of greater than or equal to 20 μm and less than or equal to 1000 μm, and may have a thickness of greater than or equal to 100 μm and less than or equal to 300 μm, for example.

The insulating covering film 102B is so provided as to cover at least a top surface 101A and a side surface 101C of the solid-state battery 101. As illustrated in FIG. 3, the entire solid-state battery 101 provided on the support substrate 102A is surrounded by the insulating covering film 102B. In some preferred embodiments, the insulating covering film 102B is so provided as to cover all of the top surface 101A and the side surface 101C of the solid-state battery 101. Of the two major surfaces included in the solid-state battery 101, a surface positioned relatively on an upper side is the top surface 101A. Of the two major surfaces included in the solid-state battery 101, a surface positioned relatively on a lower side is the bottom surface 101B. Accordingly, the top surface 101A is the major surface positioned on an opposite side to the support substrate 102A. It is therefore preferable that the insulating covering film 102B cover all of the surfaces of the solid-state battery 101, except for the bottom surface 101B. The insulating covering film 102B includes, for example, a resin material that is able to block water vapor. The insulating covering film 102B forms a favorable water vapor barrier together with the inorganic covering film 102C. Examples of a material included in the insulating covering film 102B include an epoxy-based resin, a silicone-based resin, and a liquid crystal polymer. Although the following ranges are mere examples, the insulating covering film 102B has a thickness of greater than or equal to 30 μm and less than or equal to 1000 μm, and may have a thickness of greater than or equal to 50 μm and less than or equal to 300 μm, for example.

The inorganic covering film 102C is so provided as to cover the insulating covering film 102B. The inorganic covering film 102C is positioned on the insulating covering film 102B, and therefore has a form that surrounds, together with the insulating covering film 102B, the entire solid-state battery 101 on the support substrate 102A. A material included in the inorganic covering film 102C is not particularly limited as long as the material is an inorganic material. The inorganic covering film 102C may include, for example, a metal, glass, oxide ceramics, or a mixture thereof. In some preferred embodiments, the inorganic covering film 102C includes a metal component. That is, the inorganic covering film 102C may be a thin metal film. Although the following ranges are mere examples, the inorganic covering film 102C has a thickness of greater than or equal to 0.1 μm and less than or equal to 100 μm, and may have a thickness of greater than or equal to 1 μm and less than or equal to 50 μm, for example. The inorganic covering film 102C may be a dry plating film. As used herein, the term “dry plating film” refers to a film that is obtainable by a vapor deposition method such as a physical vapor deposition (PVD) method or a chemical vapor deposition (CVD) method, and is a thin film having a markedly small thickness in nanometer or micrometer order. The dry plating film that is a thin film contributes to a decrease in size and thickness of the battery package 100. The dry plating film preferably includes, for example, at least one selected from the group consisting of aluminum (Al), nickel (Ni), palladium (Pd), silver (Ag), tin (Sn), gold (Au), copper (Cu), titanium (Ti), platinum (Pt), silicon (Si), and stainless steel. The dry plating film including such a component is chemically and thermally stable, and is therefore superior in a property such as chemical resistance, weather resistance, or heat resistance. This helps to provide the solid-state battery 101 with further improved long-term reliability.

In the battery package 100 illustrated in FIG. 3, the support substrate 102A is configured as a terminal substrate on which a substrate wiring 8 is provided. The substrate wiring 8 includes an external terminal adapted to couple the solid-state battery 101 and an external device to each other. The substrate wiring 8 of the support substrate 102A serving as the terminal substrate is not particularly limited, and may be any wiring that allows for electrical coupling between an upper surface and a lower surface of the support substrate 102A. In FIG. 3, the support substrate 102A is provided with the substrate wiring 8 including a via 8A and a pair of lands 8B and 8C. The land 8B is exposed at the upper surface of the support substrate 102A, and is electrically coupled to the positive electrode terminal 6 or the negative electrode terminal 7. The land 8C is exposed at the lower surface of the support substrate 102A. The via 8A is so provided through the support substrate 102A as to couple the land 8B and the land 8C to each other.

A brief description is given next of a method of manufacturing the battery package 100 of the present disclosure in an embodiment. The battery package 100 is fabricable by, for example, a process of manufacturing the solid-state battery 101 and a process of packaging the solid-state battery 101.

In manufacturing the stacked body 5 of the solid-state battery 101, used may be a printing method such as a screen printing method, a green sheet method in which a green sheet is used, or a combined method thereof.

One manufacturing method is described below as an example; however, the present disclosure is not limited to the following manufacturing method. Temporal matters such as the order of descriptions below are merely for description convenience, and the present disclosure is not limited thereto.

First, the positive electrode layer 10 is fabricated in accordance with the procedure in the first embodiment described above. Specifically, the positive electrode current collector 11 is prepared, following which positive electrode active material particles, a resin, and a solvent are mixed with each other to form a positive electrode slurry. Thereafter, the positive electrode slurry is applied onto both sides of the positive electrode current collector 11, following which the applied positive electrode slurry is dried to thereby form green sheets for a positive electrode on both sides of the positive electrode current collector 11. The fabricated green sheets for a positive electrode are heated at a temperature lower than 800° C. to carbonize the resin in part, thus obtaining the green sheets, having been subjected to the heating process, for a positive electrode. Lastly, the heated green sheets for a positive electrode are impregnated with a molten solid-state electrolyte for a positive electrode by, for example, dropping the molten solid-state electrolyte for a positive electrode onto the green sheets. As the molten solid-state electrolyte for a positive electrode, it is preferable to use a molten lithium salt including at least one of Li₂CO₃, Li₂SO₄, Li₃BO₃, Li₃OCl, or Li₂OHCl. In such a manner, the positive electrode layer 10 in which each of the positive electrode active material layers 12 and 13 is formed on the positive electrode current collector 11 is obtained. Note that the positive electrode slurry may be applied onto a release film instead of being applied onto the positive electrode current collector 11. In this case, the release film is removed from the green sheets for a positive electrode, following which the green sheets for a positive electrode are subjected to the heating process, thus obtaining two green sheets, having been subjected to the heating process, for a positive electrode. Thereafter, the green sheets, having been subjected to the heating process, for a positive electrode are stacked on respective opposite sides of the positive electrode current collector 11, and thereafter compression-bonded by being pressed. The positive electrode layer 10 is thereby obtained in which the positive electrode current collector 11 and the positive electrode active material layers 12 and 13 are integrated with each other.

Thereafter, the negative electrode layer 20 is fabricated in accordance with the procedure of the method of manufacturing the electrode 1 for a solid-state battery described in the first embodiment above. Specifically, negative electrode active material particles, a resin, and a solvent are mixed with each other to form a negative electrode slurry. Thereafter, the negative electrode slurry is applied onto a film, following which the applied negative electrode slurry is dried to form a green sheet for a negative electrode. The fabricated green sheet for a negative electrode is heated at a temperature lower than 800° C. to carbonize the resin in part, thus obtaining the green sheet, having been subjected to the heating process, for a negative electrode. Lastly, the heated green sheet for a negative electrode is impregnated with a molten solid-state electrolyte for a negative electrode by, for example, dropping the molten solid-state electrolyte for a negative electrode onto the green sheet. As the molten solid-state electrolyte for a negative electrode, it is preferable to use a molten lithium salt including at least one of Li₂CO₃, Li₂SO₄, Li₃BO₃, Li₃OCl, or Li₂OHCl. In such a manner, the negative electrode layer 20 is obtained.

Thereafter, a solid-state electrolyte sintered body is fabricated as follows. Specifically, first, oxide solid-state electrolyte powder and an organic binder are kneaded with each other to fabricate a kneaded powder body. Li_{0.33}La_{0.56}TiO₃ may be used as the oxide solid-state electrolyte powder. A polybutyral binder may be used as the organic binder. Thereafter, the kneaded powder body is compression-molded by, for example, a cold isostatic press (CIP) method to thereby fabricate a compression-molded body. Further, the compression-molded body is fired in an air atmosphere at a predetermined temperature for a predetermined period of time to thereby obtain the solid-state electrolyte sintered body. The firing condition is set to, for example, 1300° C. and 10 hours.

Further, materials including, without limitation, an insulating material, a binder, an organic binder, a solvent, and any additive are mixed with each other to fabricate an insulating paste.

Thereafter, the positive electrode layer 10, the solid-state electrolyte sintered body, the negative electrode layer 20, and the solid-state electrolyte sintered body are stacked on each other in order to fabricate a stacked structure. The stacked structure corresponds to one unit U illustrated in FIG. 4. In fabricating the stacked structure, the insulating paste is applied onto a location where the margin layers 41 and 42 are to be formed. The stacked structure is impregnated with a molten solid-state electrolyte for a solid-state electrolyte layer by, for example, dropping the molten solid-state electrolyte for a solid-state electrolyte layer onto the stacked structure, following which the resultant is dried. In such a manner, the solid-state electrolyte sintered body is impregnated with the solid-state electrolyte. As a result, the solid-state electrolyte layer 30 is obtained. As the molten solid-state electrolyte for a solid-state electrolyte layer, it is preferable to use a molten lithium salt including at least one of Li₂CO₃, Li₂SO₄, Li₃BO₃, Li₃OCl, or Li₂OHCl. The dried stacked structure is compressed by a method such as a cold isostatic press (CIP) method to compression-bond the positive electrode layer 10, the solid-state electrolyte layer 30, the negative electrode layer 20, and the solid-state electrolyte layer 30 to each other. Lastly, the stacked structure is heated in a nitrogen atmosphere at a temperature lower than 800° C. to thereby obtain the stacked body 5.

Thereafter, an electrically conductive paste is applied onto a side surface, of the stacked body 5 having been subjected to the heating process, where a portion of the positive electrode layer 10 is exposed. It is thereby possible to form the positive electrode terminal 6. In a similar manner, the electrically conductive paste is applied onto a side surface, of the heated stacked body 5, where a portion of the negative electrode layer 20 is exposed. It is thereby possible to form the negative electrode terminal 7. Note that the positive electrode terminal 6 and the negative electrode terminal 7 do not necessarily have to be formed on the stacked body 5 having already been subjected to the heating process. The positive electrode terminal 6 and the negative electrode terminal 7 may be formed on the stacked structure before the heating process and may be heated together with the stacked structure.

It is thereby possible to obtain the solid-state battery 101.

First, the support substrate 102A is prepared. The support substrate 102A may be obtained by, for example, stacking green sheets on each other and firing the stacked green sheets. The support substrate 102A may be prepared in a similar manner to, for example, formation of an LTCC substrate. The substrate wiring 8 including the via 8A and the lands 8B and 8C is formed in advance on the support substrate 102A. Specifically, the via 8A and the lands 8B and 8C are formed by, for example, forming a hole in a green sheet by means of, for example, a punch press or a carbon dioxide laser, and thereafter filling the formed hole with an electrically conductive paste material or performing a printing process, for example. Thereafter, a predetermined number of such green sheets are stacked on each other and thermocompression-bonded to each other to form a green sheet stacked body. The green sheet stacked body is fired. It is thereby possible to obtain the support substrate 102A on which the substrate wiring 8 is formed. Note that the substrate wiring 8 may be formed after firing the green sheet stacked body.

After the support substrate 102A is prepared as described above, the solid-state battery 101 is disposed on the support substrate 102A. At this time, the solid-state battery 101 is so disposed on the support substrate 102A that the substrate wiring 8 of the support substrate 102A and each of the positive electrode terminal 6 and the negative electrode terminal 7 of the solid-state battery 101 are electrically coupled to each other. Note that an electrically conductive paste including a material such as silver may be applied onto the substrate wiring 8 of the support substrate 102A, and the applied electrically conductive paste and each of the positive electrode terminal 6 and the negative electrode terminal 7 may be electrically coupled to each other.

Thereafter, the insulating covering film 102B is so formed as to cover the entire solid-state battery 101 on the support substrate 102A. When the insulating covering film 102B includes a resin material, the resin material is so applied as to cover the side surface 101C and the top surface 101A of the solid-state battery 101, following which the applied resin material is cured to thereby form the insulating covering film 102B. For example, the insulating covering film 102B may be shaped by applying pressure to the resin material with use of a mold having a predetermined shape. Note that the shaping of the insulating covering film 102B does not necessarily have to be performed by molding with use of the mold, and may be performed by another method such as polishing processing, laser processing, or a chemical process.

Thereafter, the inorganic covering film 102C is so formed as to cover the entire insulating covering film 102B. Specifically, the inorganic covering film 102C may be formed by performing, for example, dry plating.

Through the above-described processes, it is possible to obtain the battery package 100 in which the entire solid-state battery 101 placed on the support substrate 102A is covered with the insulating covering film 102B and the inorganic covering film 102C.

According to the battery package 100 including the solid-state battery 101 of an embodiment, the stacked body 5 of the solid-state battery 101 includes the positive electrode layer 10 and the negative electrode layer 20 in each of which the configuration of the electrode 1 for a solid-state battery described in the first embodiment above is adopted. This allows each of the positive electrode layer 10 and the negative electrode layer 20 to have a favorable electrically conductive network while having elasticity. Accordingly, in the solid-state battery 101, the positive electrode layer 10 and the negative electrode layer 20 each have a high electrically conductive property, which allows each of the positive electrode layer 10 and the negative electrode layer 20 to have a larger thickness. It is therefore possible to achieve superior performance such as a high capacity or high output.

A description is given next of applications (application examples) of the battery package including the solid-state battery described above.

The applications of the battery package are not particularly limited as long as they are, for example, machines, equipment, instruments, apparatuses, or systems (an assembly of a plurality of pieces of equipment, for example) in which the solid-state battery is usable mainly as a driving power source, an electric power storage source for electric power accumulation, or any other source. The battery package used as a power source may serve as a main power source or an auxiliary power source. The main power source is preferentially used regardless of the presence of any other power source. The auxiliary power source may be used in place of the main power source, or may be switched from the main power source on an as-needed basis. When the battery package is used as the auxiliary power source, the kind of the main power source is not limited to a power source including the solid-state battery.

Specific examples of the applications of the battery package include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use in which electric power is accumulated for a situation such as emergency. Note that the battery package may be applied to a battery module including a plurality of battery packages.

The battery module is effectively applied to relatively large-sized equipment, etc., including an electric vehicle, an electric power storage system, and an electric power tool. The electric vehicle is a vehicle that operates (travels) with the battery module as a driving power source, and may be an automobile that is additionally provided with a driving source other than the battery package including the solid-state battery. A hybrid automobile is an example of such an automobile. The electric power storage system is a system in which the battery package is used as an electric power storage source. The electric power storage system for home use accumulates electric power in the battery package serving as an electric power storage source, and the accumulated electric power may thus be utilized for using, for example, home appliances.

### 4. EXAMPLES

A description is given of Examples of the present disclosure according to an embodiment.

### Example 1

The solid-state battery 101 illustrated in FIG. 4 was fabricated, following which the solid-state battery 101 was evaluated for its battery characteristic as described below.

### (Fabrication of Positive Electrode Layer 10)

First, an aluminum foil having a thickness of 15 μm was prepared as the positive electrode current collector 11. Thereafter, lithium nickel cobalt aluminum oxide (NCA) as the positive electrode active material and polyimide as a positive electrode binder were mixed with each other to obtain a positive electrode mixture. A mixture ratio between the positive electrode active material and the positive electrode binder was set to 80:20. Thereafter, the positive electrode mixture was put into NMP (N-methyl-2-pyrrolidone) as an organic solvent, following which the organic solvent into which the positive electrode mixture had been put was stirred to thereby prepare a positive electrode slurry in paste form. The stirring was performed by means of a hybrid mixer at a rotation speed of 2000 rpm for 3 minutes. Thereafter, the positive electrode slurry was applied onto a predetermined region of each of the opposite sides of the positive electrode current collector 11 by means of a coating apparatus, following which the applied positive electrode slurry was dried to thereby form a green sheet for a positive electrode on each of the opposite sides of the positive electrode current collector 11. The fabricated green sheets for a positive electrode were heated at a temperature of 800° C. for 1 hour to carbonize the resin in part, thus obtaining the green sheets, having been subjected to the heating process, for a positive electrode. Lastly, the heated green sheets for a positive electrode were impregnated with pure water in which Li₂OHCl was melted as the molten lithium salt by dropping the pure water in which Li₂OHCl was melted onto the green sheets. The positive electrode layer 10 was thus obtained.

### (Fabrication of Negative Electrode Layer 20)

A carbon material including natural graphite as the negative electrode active material and polyimide as a negative electrode binder were mixed with each other to obtain a negative electrode mixture. A mixture ratio between the negative electrode active material and the negative electrode binder was set to 80:20. Thereafter, the negative electrode mixture was put into NMP (N-methyl-2-pyrrolidone) as an organic solvent, following which the organic solvent into which the negative electrode mixture had been put was stirred to thereby prepare a negative electrode slurry in paste form. The stirring was performed by means of a hybrid mixer at a rotation speed of 2000 rpm for 3 minutes. Thereafter, the negative electrode slurry was applied onto a release film including polyethylene terephthalate (PET) by means of a coating apparatus, following which the applied negative electrode slurry was dried to thereby form a green sheet for a negative electrode on the release film. The fabricated green sheet for a negative electrode was heated at a temperature of 700° C. for 1 hour to carbonize the resin in part, thus obtaining the green sheet, having been subjected to the heating process, for a negative electrode. Lastly, the heated green sheet for a negative electrode was impregnated with pure water in which Li₂OHCl was melted as the molten lithium salt by dropping the pure water in which Li₂OHCl was melted onto the green sheet. The negative electrode layer 20 was thus obtained.

### (Fabrication of Solid-State Electrolyte Sintered Body)

Li_{0.33}La_{0.56}TiO₃ as the oxide solid-state electrolyte powder, a polyacrylic binder as the organic binder, and butyl acetate were kneaded to prepare a kneaded powder body. A mixture ratio between Li_{0.33}La_{0.56}TiO₃, the polyacrylic binder, and butyl acetate was set to 50:10:40. Thereafter, the kneaded powder body was compression-molded by a cold isostatic press (CIP) method at a pressure of 200 MPa to fabricate a compression-molded body. Further, the compression-molded body was fired in an air atmosphere at a temperature of 1300° C. for 10 hours. A solid-state electrolyte sintered body was thus obtained.

### (Fabrication of Stacked Body 5)

Thereafter, the positive electrode layer 10, the solid-state electrolyte sintered body, the negative electrode layer 20, and the solid-state electrolyte sintered body, each of which had been fabricated as described above, were stacked on each other in order to fabricate a stacked structure. The stacked structure was impregnated with pure water in which Li₂OHCl was melted as the molten lithium salt by dropping the pure water in which Li₂OHCl was melted onto the stacked structure, following which the stacked structure is dried. The dried stacked structure was compressed by a cold isostatic press (CIP) method to compression-bond the positive electrode layer 10, the solid-state electrolyte layer 30, the negative electrode layer 20, and the solid-state electrolyte layer 30 to each other. Lastly, the stacked structure was heated in a nitrogen atmosphere at a temperature of 270° C. for 1 hour to thereby obtain the stacked body 5.

Thereafter, the electrically conductive paste was applied onto a side surface, of the sintered stacked body 5, where a portion of the positive electrode layer 10 was exposed, to thereby form the positive electrode terminal 6. The electrically conductive paste was applied onto a side surface, of the sintered stacked body 5, where a portion of the negative electrode layer 20 was exposed, to thereby form the negative electrode terminal 7.

In such a manner, the solid-state battery 101 was obtained. Note that the mixture ratio between the positive electrode active material and the positive electrode binder in the positive electrode layer 10 having been subjected to the heating process was 95:5 in weight ratio. A reason for this is that an organic component included in the positive electrode binder was decomposed and volatilized in part by carbonization. The mixture ratio between the negative electrode active material and the negative electrode binder in the negative electrode layer 20 having been subjected to the heating process was also 95:5 in weight ratio because of a similar reason.

### (Battery Characteristic Evaluation)

Evaluation of the solid-state battery 101 for its battery characteristic revealed the result presented in Table 1. Here, the solid-state battery 101 was evaluated for a charge capacity [mAh/g] and an initial charge and discharge efficiency [%] in an environment at a temperature of 90° C. The solid-state battery 101 of Example 1 was charged and discharged as follows. First, the solid-state battery 101 was charged with a constant current of 0.5 mA until a battery voltage reached 4.2 V, and was charged with a constant voltage of 4.2 V until a battery current reached 0.05 mA. Thereafter, the solid-state battery 101 was discharged with a constant current of 0.5 mA until the battery voltage reached 2.0 V. The above-described combination of charging and discharging was regarded as one cycle. A ratio of a first-cycle discharge capacity to a first-cycle charge capacity, that is, (first-cycle discharge capacity/first-cycle charge capacity)×100(%) was calculated as the initial charge and discharge efficiency. For the charge capacity, an electric capacity of the solid-state battery 101 that had been charged with the constant current as described above was measured, following which a charge capacity per gram of the positive electrode active material layers 12 and 13 (a charge capacity of the positive electrode) was calculated.

### Examples 2 to 4

The solid-state batteries 101 were each fabricated in a manner similar to that in Example 1, except that the heating temperature for the positive electrode layer 10 was changed within a range from 700° C. to 500° C. both inclusive as indicated in Table 1, following which the solid-state batteries 101 were each evaluated for its respective battery characteristic in a manner similar to that in Example 1. The results of the evaluation are also presented in Table 1.

### Example 5

The solid-state battery 101 was fabricated in a manner similar to that in Example 1, except that cobalt lithium dioxide (LCO: LiCoO₂) was used instead of NCA as the positive electrode active material, following which the solid-state battery 101 was evaluated for its battery characteristic in a manner similar to that in Example 1. The result of the evaluation is also presented in Table 1.

### Example 6

The solid-state battery 101 was fabricated in a manner similar to that in Example 1, except that lithium titanate (LTO: Li₂TiO₃) was used instead of NCA as the positive electrode active material, following which the solid-state battery 101 was evaluated for its battery characteristic in a manner similar to that in Example 1. The result of the evaluation is also presented in Table 1.

### Example 7

The solid-state battery 101 was fabricated in a manner similar to that in Example 1, except that Li₃BO₃ was used instead of Li₂OHCl as the molten lithium salt, following which the solid-state battery 101 was evaluated for its battery characteristic in a manner similar to that in Example 1. The result of the evaluation is also presented in Table 1.

### Example 8

The solid-state battery 101 was fabricated in a manner similar to that in Example 1, except that Li₂CO₃ was used instead of Li₂OHCl as the molten lithium salt, following which the solid-state battery 101 was evaluated for its battery characteristic in a manner similar to that in Example 1. The result of the evaluation is also presented in Table 1.

### Example 9

The solid-state battery 101 was fabricated in a manner similar to that in Example 1, except that Li₂SO₄ was used instead of Li₂OHCl as the molten lithium salt, following which the solid-state battery 101 was evaluated for its battery characteristic in a manner similar to that in Example 1. The result of the evaluation is also presented in Table 1.

### Example 10

The solid-state battery 101 was fabricated in a manner similar to that in Example 1, except that Li₃OCl was used instead of Li₂OHCl as the molten lithium salt, following which the solid-state battery 101 was evaluated for its battery characteristic in a manner similar to that in Example 1. The result of the evaluation is also presented in Table 1.

### Example 11

The solid-state battery 101 was fabricated in a manner similar to that in Example 1, except that Li₂(OH)Cl_{0.9}F_{0.1} was used instead of Li₂OHCl as the molten lithium salt, following which the solid-state battery 101 was evaluated for its battery characteristic in a manner similar to that in Example 1. The result of the evaluation is also presented in Table 1.

### Comparative Example 1

The solid-state battery 101 was fabricated in a manner similar to that in Example 1, except that the heating temperature for the positive electrode layer 10 was changed to 900° C., following which the solid-state battery 101 was evaluated for its battery characteristic in a manner similar to that in Example 1. The result of the evaluation is presented in Table 2.

### Comparative Example 2

The solid-state battery 101 was fabricated in a manner similar to that in Example 1, except that the heating process was not performed when the positive electrode layer 10 and the negative electrode layer 20 were fabricated, following which the solid-state battery 101 was evaluated for its battery characteristic in a manner similar to that in Example 1. The result of the evaluation is also presented in Table 2.

### Comparative Example 3

The solid-state battery 101 was fabricated in a manner similar to that in Example 1, except that polyvinylidene difluoride (PVDF) was used instead of polyimide as the positive electrode binder, following which the solid-state battery 101 was evaluated for its battery characteristic in a manner similar to that in Example 1. The result of the evaluation is also presented in Table 2.

### Comparative Example 4

The solid-state battery 101 was fabricated in a manner similar to that in Example 1, except that the heating process was not performed when the positive electrode layer 10 and the negative electrode layer 20 were fabricated, and polyvinylidene difluoride (PVDF) was used instead of polyimide as the positive electrode binder, following which the solid-state battery 101 was evaluated for its battery characteristic in a manner similar to that in Example 1. The result of the evaluation is also presented in Table 2.

### Comparative Example 5

The solid-state battery 101 was fabricated in a manner similar to that in Example 1, except that a polyacrylic acid was used instead of polyimide as the positive electrode binder, following which the solid-state battery 101 was evaluated for its battery characteristic in a manner similar to that in Example 1. The result of the evaluation is also presented in Table 2.

### Comparative Example 6

The solid-state battery 101 was fabricated in a manner similar to that in Example 1, except that the heating process was not performed when the positive electrode layer 10 and the negative electrode layer 20 were fabricated, and a polyacrylic acid was used instead of polyimide as the positive electrode binder, following which the solid-state battery 101 was evaluated for its battery characteristic in a manner similar to that in Example 1. The result of the evaluation is also presented in Table 2.

TABLE 1

| | | | | | | Initial charge |
|---|---|---|---|---|---|---|
| | Positive electrode | | Firing | | Charge | and discharge |
| | Active | | temperature | Solid-state | capacity | efficiency |
| | material | Binder | [° C.] | electrolyte | [mAh/g] | [%] |
| Example 1 | NCA | PI | 800 | Li₂(OH)Cl | 192 | 85 |
| Example 2 | NCA | PI | 700 | Li₂(OH)Cl | 193 | 86 |
| Example 3 | NCA | PI | 600 | Li₂(OH)Cl | 194 | 83 |
| Example 4 | NCA | PI | 500 | Li₂(OH)Cl | 199 | 80 |
| Example 5 | LCO | PI | 700 | Li₂(OH)Cl | 153 | 87 |
| Example 6 | LTO | PI | 700 | Li₂(OH)Cl | 148 | 89 |
| Example 7 | NCA | PI | 700 | Li₃BO₃ | 172 | 74 |
| Example 8 | NCA | PI | 700 | Li₂CO₃ | 121 | 44 |
| Example 9 | NCA | PI | 700 | Li₂SO₄ | 87 | 42 |
| Example 10 | NCA | PI | 700 | Li₃OCl | 190 | 88 |
| Example 11 | NCA | PI | 700 | Li₂(OH)Cl_{0.9}F_{0.1} | 193 | 97 |

TABLE 2

| | | | | | | Initial charge |
|---|---|---|---|---|---|---|
| | Positive electrode | | Firing | | Charge | and discharge |
| | Active | | temperature | Solid-state | capacity | efficiency |
| | material | Binder | [° C.] | electrolyte | [mAh/g] | [%] |
| Comparative | NCA | PI | 900 | Li₂(OH)C1 | 194 | 55 |
| example 1 | | | | | | |
| Comparative | NCA | PI | Not fired | Li₂(OH)C1 | 84 | 77 |
| example 2 | | | | | | |
| Comparative | NCA | PVDF | 700 | Li₂(OH)Cl | 22 | 68 |
| example 3 | | | | | | |
| Comparative | NCA | PVDF | Not fired | Li₂(OH)C1 | 5 | 0 |
| example 4 | | | | | | |
| Comparative | NCA | Polyacrylic acid | 700 | Li₂(OH)Cl | 0 | 0 |
| example 5 | | | | | | |
| Comparative | NCA | Polyacrylic acid | Not fired | Li₂(OH)Cl | 12 | 18 |
| example 6 | | | | | | |

As indicated in Tables 1 and 2, it was found from comparison of Examples 1 to 11 and Comparative examples 1 to 6 that it was possible to improve the charge capacity by subjecting the positive electrode layer 10 and the negative electrode layer 20 to the heating process. A possible reason for this is that polyimide included in each of the positive electrode layer 10 and the negative electrode layer 20 was carbonized in part by the heating process to form a favorable electrically conductive network while providing elasticity and to thereby achieve a favorable electrically conductive property.

Although the present disclosure has been described above with reference to one or more embodiments including modifications and Examples, the configuration of the present disclosure is not limited thereto, and is therefore modifiable in a variety of ways.

For example, the description has been given of the battery package 100 in which the solid-state battery 101 is placed on the support substrate 102A and is packaged; however, the battery package of the present disclosure is not limited thereto. For example, the support substrate may be omitted and sealing may be achieved simply by, for example, the insulating covering film and the inorganic covering film.

Further, the description has been given of the case where the electrode reactant is lithium; however, the electrode reactant is not particularly limited. Therefore, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present disclosure are not limited thereto. Accordingly, the present disclosure may achieve any other effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrode for a solid-state battery, the electrode comprising:
active material particles;
a resin provided to allow the active material particles to be coupled to each other, the resin including one or more of polyimide, polyamide, and polyamideimide and including a carbide in part; and
an inorganic solid-state electrolyte including a lithium salt that includes at least one element selected from the group consisting of boron (B), carbon (C), sulfur (S), and chlorine (Cl).

2. The electrode for a solid-state battery according to claim 1, wherein the inorganic solid-state electrolyte is provided in a gap between the active material particles.

3. The electrode for a solid-state battery according to claim 1, wherein the inorganic solid-state electrolyte includes, as the lithium salt, at least one of Li₂CO₃, Li₂SO₄, Li₃BO₃, Li₃OCl, Li₂OHCl, Li₇PS₆, Li₆PS₅Cl, Li₆PS₅Br, Li₁₀GeP₂S₁₂, Li₁₀SiP₂S₁₂, Li_{9.54}Si_{1.74}P_{1.44}S_{11.7}C_{10.3}, Li₂MCl₄ where M includes at least one of Mg, Fe, Ni, Zn, Al, In, or Sc, or Li₃MCl₆ where M includes at least one of Al, Ga, In, Sc, or Y.

4. A method of manufacturing an electrode for a solid-state battery, the method comprising:
forming a slurry by mixing an active material particle, a resin, and a solvent, the resin including at least one selected from the group consisting of polyimide, polyamide, and polyamideimide;
forming a green sheet by applying the slurry onto a film and thereafter drying the slurry applied;
carbonizing, in part, the resin in the green sheet by heating; and
impregnating the green sheet in which the resin has been carbonized in part with a molten inorganic solid-state electrolyte.

5. A solid-state battery comprising:
a positive electrode;
a negative electrode; and
a solid-state electrolyte layer interposed between the positive electrode and the negative electrode, wherein
at least one of the positive electrode or the negative electrode includes
active material particles,
a resin provided to allow the active material particles to be coupled to each other, the resin including at least one selected from the group consisting of polyimide, polyamide, and polyamideimide and including a carbide in part, and
an inorganic solid-state electrolyte including a lithium salt that includes at least one element selected from the group consisting of boron (B), carbon (C), sulfur (S), and chlorine (Cl).

6. The solid-state battery according to claim 5, wherein the inorganic solid-state electrolyte is provided in a gap between the active material particles.

7. The solid-state battery according to claim 5, wherein the inorganic solid-state electrolyte includes, as the lithium salt, at least one of Li₂CO₃, Li₂SO₄, Li₃BO₃, Li₃OCl, Li₂OHCl, Li₇PS₆, Li₆PS₅Cl, Li₆PS₅Br, Li₁₀GeP₂S₁₂, Li₁₀SiP₂S₁₂, Li_{9.54}Si_{1.74}P_{1.44}S_{11.7}C_{10.3}, Li₂MCl₄ where M includes at least one of Mg, Fe, Ni, Zn, Al, In, or Sc, or Li₃MCl₆ where M includes at least one of Al, Ga, In, Sc, or Y.

8. The solid-state battery according to claim 5, wherein
the solid-state electrolyte layer includes
a first solid-state electrolyte having a perovskite structure having a lattice constant that is an integer multiple of a value of greater than or equal to 3.8 angstroms and less than or equal to 4.1 angstroms, and
a second solid-state electrolyte having an antiperovskite structure having a lattice constant that is an integer multiple of a value of greater than or equal to 3.8 angstroms and less than or equal to 4.1 angstroms.

9. The solid-state battery according to claim 8, wherein
the first solid-state electrolyte includes electrolyte particles, and
the second solid-state electrolyte is provided between the electrolyte particles.

10. The solid-state battery according to claim 8, wherein
the first solid-state electrolyte comprises Li_{0.33}La_{0.56}TiO₃, and
the second solid-state electrolyte comprises Li₃OCl or Li₂OHCl.

11. A method of manufacturing a solid-state battery, the method comprising:
forming each of a positive electrode, a negative electrode, and a solid-state electrolyte layer; and
forming a stacked structure body including the positive electrode, the negative electrode, and the solid-state electrolyte layer, wherein
the forming of the positive electrode includes
forming a positive electrode slurry by mixing a positive electrode active material particle, a first resin, and a first solvent with each other, the first resin including at least one selected from the group consisting of polyimide, polyamide, and polyamideimide,
forming a first green sheet by applying the positive electrode slurry onto a first film and thereafter drying the positive electrode slurry applied,
carbonizing, in part, the first resin in the first green sheet by heating, and
impregnating the first green sheet in which the first resin has been carbonized in part with a molten first inorganic solid-state electrolyte,
the forming of the negative electrode includes
forming a negative electrode slurry by mixing a negative electrode active material particle, a second resin, and a second solvent with each other, the second resin including at least one selected from the group consisting of polyimide, polyamide, and polyamideimide,
forming a second green sheet by applying the negative electrode slurry onto a second film and thereafter drying the negative electrode slurry applied,
carbonizing, in part, the second resin in the second green sheet by heating, and
impregnating the second green sheet in which the second resin has been carbonized in part with a molten second inorganic solid-state electrolyte, and
the forming of the stacked structure body includes
forming a stacked body by stacking the positive electrode, the solid-state electrolyte layer, and the negative electrode on each other in order, and thereafter impregnating the stacked body with a molten third inorganic solid-state electrolyte, and
applying pressure to the stacked body to compression-bond the positive electrode, the solid-state electrolyte layer, and the negative electrode to each other, and thereafter heating the stacked body at a temperature lower than 800 degrees Celsius.

12. A battery package comprising:
a solid-state battery; and
a covering part covering the solid-state battery, wherein
the solid-state battery includes
a positive electrode,
a negative electrode, and
a solid-state electrolyte layer interposed between the positive electrode and the negative electrode, and
at least one of the positive electrode or the negative electrode includes
active material particles,
a resin provided to allow the active material particles to be coupled to each other, the resin including at least one selected from the group consisting of polyimide, polyamide, and polyamideimide and including a carbide in part, and
an inorganic solid-state electrolyte including a lithium salt that includes at least one element selected from the group consisting of boron (B), carbon (C), sulfur (S), and chlorine (Cl).
